(19) United States
(12) Patent Application Publication
(10) Pub. No.: US 2021/0085133 A1
(43) Pub. Date: Mar. 25, 2021

(54) SEPARATION UNIT AND A DISPENSER COMPRISING A SEPARATION UNIT

(71) Applicant: ESSITY HYGIENE AND HEALTH AKTIEBOLAG, Göteborg (SE)

(72) Inventors: Björn LARSSON, Billdal (SE); Per MOLLER, Borlänge (SE); David SAHLIN, Borlänge (SE); Lars THORÉN, Borlänge (SE)

(73) Assignee: ESSITY HYGIENE AND HEALTH AKTIEBOLAG, Göteborg (SE)

(21) Appl. No.: 17/083,873

(22) Filed: Oct. 29, 2020

Related U.S. Application Data
(63) Continuation of application No. 14/438,443, filed on Apr. 24, 2015, now abandoned.
Application No. 14/438,443 is a continuation-in-part of application No. PCT/SE2012/051158, filed on Oct. 26, 2012.

(51) Int. Cl. A47K 10/36; A47K 10/44; B65H 20/02; B26F 3/00

(52) U.S. Cl. CPC A47K 10/36; A47K 10/3643; A47K 10/16; B65H 20/02; B26F 3/002; A47K 10/44

(57) ABSTRACT

A separation unit for separating a web material along preformed lines of weakness. The separation unit includes a first roller, and a second roller having a rotational axis extending parallel with the rotational axis of the first roller. The rotational axis of the second roller is positioned at a distance from the rotational axis of said first roller. Each of the first and second rollers is provided with at least one protrusion element. Outer portions of the protrusion elements on the first roller are partially overlapping with outer portions of the protrusion elements on the second roller with a radial overlap length, thus forming an undulating passage for a web material between the rollers. The distance between the rotational axes of the first and the second rollers is adjustable, enabling the radial overlap length in the undulating passage to be variable. Also, a dispenser including the separation unit.

### CROSS REFERENCE TO RELATED APPLICATIONS

The present application is a continuation of U.S. application Ser. No. 14/438,443, filed on Apr. 24, 2015, which is a U.S. national stage of International Application No. PCT/SE2013/050204, filed on Mar. 8, 2013, which is a continuation in part of International Application No. PCT/SE2012/051158, filed on Oct. 26, 2012. The entire contents of each of U.S. application Ser. No. 14/438,443, International Application No. PCT/SE2013/050204, and International Application No. PCT/SE2012/051158 are hereby incorporated herein by reference in their entirety.

### TECHNICAL FIELD

The present invention concerns a separation unit for separating a perforated web material such as paper towels, tissue paper, or nonwoven material along perforation lines.

The present invention further relates to a dispenser for a web material, comprising a housing defining a web material reservoir, a dispensing opening, and a separation unit.

### BACKGROUND

Automatic touchfree dispensers (or “hands-free dispensers”) for paper towels are known on the market. The hands-free dispensers are electronically maneuvered, they store and advance the paper towel with different kinds of control devices, sensors and power sources available. Without touching the dispenser, the user can get a paper towel that is fed automatically by the electronic dispenser. Dispensers like this are commonly used in public lavatories for dispensing paper towels to users. The most common type of a powered, hands-free dispenser is a roll dispenser that users sensors to initiate the mechanisms for advancing the towel such that the subsequent sheet is presented to the user.

Rolls of paper towels are often heavy and there is a friction and resistance for unrolling the paper. Especially when the roll is accelerated there is a high demand of energy. Consequently, there is a need for a strong paper in order to withstand the force necessary to make a full heavy roll to start rotating. A strong paper usually has drawbacks in that the softness of the paper is low. In addition, hands-free dispensers for rolled paper towels demand a large amount of space due to the relatively large volume of the heavy paper rolls.

As an alternative to rolls of paper towels, e.g. US2011/0101020, WO 2011/045493, EP 1 830 687 all disclose dispensing units comprising a housing for holding a pile of a continuous length of accordion-like folded web of towels. That is, a web material for e.g. wiping purposes may be provided in the form of a stack. Different kinds of dispensers for holding such a stack of web material, and for dispensing separate sheets of web material from such a stack, are known. Generally, there may be distinguished between two kinds of dispensers for stacks of web material; a first kind of dispenser from which sheets of web material are dispensed from a bottom end of the stack, and a second kind of dispenser from which sheets of web material are dispensed from a top end of the stack. The first kind of dispenser is easily replenished with web material by placing a bundle of web material on top of the web material remaining in the dispenser. Replenishing a dispenser of the second kind may pose a problem because the stack often has to be replenished from the bottom end. It may be mentioned that in some types of dispensers, e.g. dispensers for napkins, the stack may be arranged in a horizontal direction. The stack may be biased towards a dispensing opening and napkins may be dispensed from a top of the stack from the dispensing opening. Replenishing the latter type of dispensers may pose its own particular problems.

U.S. Pat. No. 2,809,082, with reference to its FIG. 6, discloses a dispenser wherein paper is fed from a top of a stack. The stack is replenished from its bottom.

WO2007/000153 discloses a double dispenser for dispensing of disposable paper. Each dispenser unit comprises: a stack magazine for accommodating a folded paper web; an advancing unit for conveying the paper web out of the stack magazine for further use; a detaching device for detaching the disposable paper towels from the paper web, and; a dispensing unit for dispensing the detached disposable paper towels from the dispenser. Paper web is replenished by placing new paper web beneath remaining web paper in the dispenser and gluing the new paper to the remaining web paper.

US 2011/0101020 discloses a dispenser comprising a housing with a back plate and a cover. A base of the cover is articulated on a connecting pin. A support-container holds a stack of pre-cut material which is in use and can hold a spare stack. A base of the support-container is articulated around the same axis of rotation and the cover internally has a horizontal plate which supports the stack in use after swiveling the cover and support-container to load the spare stack. The support-container fits inside and is dismountably attached to the housing after swiveling into the internal space of the housing, which causes downward displacement of the stack in use, allowing the spare stack to be inserted into the internal space. That is, the support-container is turned upside down to access a bottom of the stack in use for replenishing the dispenser with the spare stack. The stack in use and the spare stack are joined to each other after positioning the spare stack on the other stack.

EP 1 830 687 discloses a dispenser comprising a housing for holding a pile of a continuous length of accordion-like folded web of towels. The dispenser comprises an access opening to the pile, a dispensing opening for the web of towels, a feeding mechanism comprising a member for controlling the dispensing of the web of towels, and a drive unit. Bundles of paper towels with connecting means therebetween are insertable through the access opening into the housing in the dispensing unit and may be added to the bottom of the pile. The connecting means comprise glue or an adhesive or pressure sensitive tape. The web of towels is dispensable from the upper part of the pile by the feeding mechanism, which positions the web of towels in a starting mode in the dispensing opening. This solution enables feeding of a large amount of wipe products while avoiding the problems relating to the weight of a heavy paper roll or large pile.

A dispenser for perforated web material may be provided with a separation unit for separating a sheet of web material along a perforation from the web material in the dispenser. A perforated web material is a web material which is provided with preformed lines of weaknesses arranged to break when a user pulls on a leading portion of the web material to dispense a sheet of web material. The separation unit may comprise a nip through which the web material is arranged to pass. A perforation of the web material may break within the nip or outside the nip as a user pulls on the leading portion of the web material.

However, to realize the dispenser as described above a number of problems must be solved, including separating the webs correctly along the perforation lines, feeding the next portion of the web to be separated to the separation unit, and presenting the leading end of the web to the next user. Furthermore, separation shall be possible for different types of web materials and web materials having different lengths between the perforation lines.

In a dispenser for a stack of folded continuous web material wherein the dispenser comprises a separation unit comprising a nip, a connection means arranged between two bundles of folded web material, such as the connection means discussed above, may interfere with proper operation of the dispenser. For instance, the connection arrangement may get stuck in the nip or the web material may rupture in connection with the connection means.

### SUMMARY

An object of the present invention is to provide a separation unit, which provides proper operation with different kinds of web material and/or a web material comprising bundles of web material being joined by connection means.

According to an aspect of the invention, the object is achieved by a separation unit for separating a web material along preformed lines of weakness, the separation unit having a width direction and comprising at least a first roller having a rotational axis extending in the width direction and a web width extending in the width direction, and at least a second roller having a rotational axis extending parallel with the rotational axis of the first roller and a web width extending in the width direction. The rotational axis of the second roller is positioned at a distance from the rotational axis of the first roller, the said distance extending in a direction perpendicular to the width direction. Each of the first and the second rollers is provided with at least one protrusion element extending perpendicularly from the said axes. Each of the protrusion elements has a maximum width in the width direction, a maximum radial extension from the rotational axes, an inner portion adjacent to the rotational axes, and an outer portion remote from the rotational axes. The outer portions of the protrusion elements on the first roller are arranged in a staggered relationship with the outer portions of the protrusion elements on the second roller. The outer portions of the protrusion elements on the first roller are partially overlapping with the outer portions of the protrusion elements on the second roller with a radial overlap length, thus forming an undulating passage for a web material between the rollers. The said distance between the rotational axes of the first and the second rollers is adjustable, enabling the radial overlap length in the undulating passage to be variable.

Since the distance between the rotational axes of the rollers is adjustable and the radial overlap length in the undulating passage is variable, web material of different kinds may be arranged to pass between the rollers, while still preformed lines of weakness will rupture in the separation unit to separate a sheet of web material, and/or connection means between bundles of web material in a stack of web material may pass between the rollers. As a result, the above mentioned object is achieved.

The separation unit may be provided in a dispenser for perforated web material. A web material provided with preformed lines of weaknesses may be referred to as a perforated web material. The preformed lines of weakness are arranged to break when a user pulls on a leading portion of the web material to dispense a sheet of web material from a relevant dispenser comprising the separation unit. The separation unit comprises a nip formed between the first and second rollers, through which nip the web material is arranged to pass. A preformed line of weakness may break either within the nip or outside nip, as a user pulls on a leading portion of the web material from a relevant dispenser comprising the separation unit. Thus, a sheet of web material may be separated from a leading portion of web material. The web material may be provided e.g. for wiping purposes and may be provided in the form of a stack or a roll in a relevant dispenser comprising the separation unit. Web material may be of different kinds e.g. in the sense that they comprise different materials, have different thicknesses, comprise different numbers of layers, and/or have different perforation strengths.

According to embodiments, a biasing means arranged with the rollers enables an automatic adjustment of the distance between the rotational axes of the first and the second rollers. In this manner a connection means joining two bundles of web material in a stack of web material may pass between the rollers.

According to embodiments, the rollers may be arranged such that the distance between the rotational axes of the first and the second rollers is manually changeable. In this manner at least a maximum radial overlap length may be set to adapt the separation unit for web material of different kinds.

According to embodiments, the separation unit may comprise a biasing means. The first roller may be movably suspended, perpendicularly to the first rotational axis. The biasing means may be arranged to bias the first roller towards the second roller. In this manner the first roller may be resiliently suspended in the separation unit to permit the automatic adjustment of the distance between the rotational axes of the first and second rollers.

According to embodiments, the separation unit may comprise a cradle. The cradle may be pivotably suspended to pivot about a pivot axis substantially parallel with the rotational axes. The first roller may be suspended in the cradle. In this manner the distance between the rotational axes of the first and the second rollers may be adjustable by the first roller being able to pivot together with the cradle about the pivot axis.

According to embodiments, the biasing means may engage with the cradle to bias the first roller towards the second roller. In this manner an uncomplicated and efficient biasing of the first roller towards the second roller may be achieved. Also, the automatic adjustment of the distance between the rotational axes of the first and the second rollers may be achieved in this manner.

According to embodiments, the rotational axis of the second roller may be fixed. More specifically, the rotational axis of the second roller may be fixed during use of the separation unit for separating sheets of web material from a continuous web material. The second roller however, may be movable away from the first roller to permit threading of web material between the first and second rollers.

According to embodiments, the biasing means may bias the first roller towards an end position, from which end position the first roller is movable in a direction away from the second roller. In this manner a smallest distance between the first and second rollers, and a maximum radial overlap length, may be defined by the end position.

According to embodiments, the cradle may be biased to abut against a stopper device. The first roller may be arranged in the end position when the cradle abuts against the stopper device. In this manner the first roller may be biased towards the end position and the smallest distance between the first and second rollers may be defined by the cradle abutting against the stopper device.

According to embodiments, the stopper device may be movable between at least two fixed positions to define at least two corresponding end positions for the first roller. In this manner the end position, and accordingly the smallest distance between the first and second rollers, may be set by moving the stopper device to one of the at least two fixed positions.

According to embodiments, in a fixed position of the stopper device, the radial overlap length may be approx. 6 mm, or approx. 7 mm, or approx. 8 mm in a respective end position of the first roller. In this manner a nip formed between the first and second rollers may be set for a particular web material such that a sheet of web material may be separated from a perforated web material in the separation unit.

According to embodiments, the biasing means may comprise a spring. The spring may be e.g. a helical pressure spring, a helical tension spring, or a torsional spring. Other examples of biasing means comprise a gas spring, or a resilient element such as a rubber element.

According to embodiments, the separation unit may comprise a first guiding part separate from the first roller. The first guiding part may be arranged in connection with the first roller and may comprise a first guiding surface for the web material. In this manner web material passing through the separation unit, at least in some situations, may be guided by the first guiding surface.

According to embodiments, the first guiding part may be connected with, and movable together with, the cradle.

According to embodiments, the separation unit may comprise a second guiding part separate from the second roller. The second guiding part may be arranged in connection with the second roller and may comprise a second guiding surface for the web material. In this manner a web material passing through the separation unit, at least in some situations, may be guided by the second guiding surface.

According to embodiments, the protrusion elements may be disc elements.

A further object of the present invention is to provide a dispenser for a web material comprising preformed lines of weakness, which dispenser provides proper operation with different kinds of web material and/or a web material comprising bundles of web material being joined by connection means.

According to an aspect of the invention, the object is achieved by a dispenser for a web material comprising preformed lines of weakness. The dispenser comprises a housing defining a web material reservoir, a dispensing opening, and a separation unit according to aspects and embodiments discussed herein.

The dispenser may be a standalone unit or may be mounted to a structure such as a wall, a piece of furniture, or a door. The dispenser may be arranged for manual dispensing of web material through the dispensing opening by a user pulling on a leading portion of the web material. The dispenser may alternatively be arranged for automatic dispensing of web material through the dispensing opening. The automatic dispensing may comprise an electrically powered feeding mechanism for the web material or a mechanical feeding mechanism for the web material. In both cases a user may actuate the feeding.

According to embodiments, the dispenser may comprise a control unit for determining a correct tension and path of the web material. In this manner a secure transition of web material through the dispenser may be ensured.

According to embodiments, the dispenser may be adapted for containing a web material comprising preformed lines of weakness. The web material may be Z-folded to form a stack.

The web material may be provided as a continuous web material which is folded to form a stack of folded web material. Similarly, a bundle of folded web material for replenishing a stack of folded web material in a dispenser may comprises a continuous web material. Herein, the term “replenishing” not only relates to the replenishing of a dispenser which is partially filled with a stack of folded web material, but is understood to also encompass loading of an empty dispenser. From a leading portion of web material from the stack of folded web material, sheets of web material are separated during dispensing. Dispensed sheets of web material from the dispenser may be used as towels, napkins, for general wiping, etc. The folded web material may be Z-folded in an accordion-like manner to form the stack of folded web material. The web material may comprise one or more web layers. In the case of more than one web layer, the layers are interfolded in the stack. One or more sheets of web material may be separated from the web material by the separation unit of the dispenser during dispensing from the dispenser. For this purpose the web material is provided with preformed lines of weakness, perforations. One or more bundles of folded web material are arranged to be placed in the web material reservoir of the dispenser to form a stack of folded web material. The leading portion of the web material is arranged to extend from the upper end portion of the web material reservoir to the dispensing opening of the dispenser. The leading portion of the web material may change direction one or more times inside the dispenser between the upper end portion of the web material reservoir and the dispensing opening.

According to embodiments, the dispenser may be adapted for containing a web material comprising preformed lines of weakness. The web material may be in the form of a roll.

According to embodiments, the dispenser may comprise a feeding mechanism for feeding the web material.

According to embodiments, the web material reservoir may be adapted to contain the web material. A leading portion of the web material may be arranged to be supported at least partially along a dispensing path from the reservoir to the dispensing opening. In this manner a secure transition of web material through the dispenser may be ensured.

The control unit may form one component supporting the web material, the separation unit may form a further component supporting the web material.

According to embodiments, the leading portion may be arranged to extend upwardly from a top of the stack. In this manner dispensing from the stack may take place from the top of the stack.

According to aspects of the present invention, a separation unit for separating a web material along preformed lines of weakness is provided. The separation unit has a width direction and comprises at least a first roller having a rotational axis extending in the width direction and a web width extending in said width direction, and at least a second roller having a rotational axis extending parallel with said rotational axis of said first roller and a web width extending in said width direction. A web width of a roller is a portion of the roller extending along the width direction of the roller. Over the web width of the roller the web material is arranged to pass during dispensing of the web material. The second roller is positioned at a distance from the first roller. The distance between the rollers extends in a direction perpendicular to the width direction. The rollers are thus positioned such that the rotational axes are juxtaposed. The separation unit may comprise more than two rollers, positioned at a distance from each other, wherein the distance between the rollers extends in a direction perpendicular to the width direction. Each of said rollers is provided with at least one protrusion element extending radially perpendicular from said axes. Each of said protrusion elements has a maximum width in said width direction, a maximum radial extension from said rotational axes, an inner portion adjacent to said rotational axes, and an outer portion remote from said rotational axes. By “maximum width” is meant the maximal extension of the protrusion element in the width direction. By “maximum radial extension” is meant the distance from the rotational axis of the roller to the most remote point on the protrusion element in the radial direction being perpendicular to the width direction of the rotational axis. It is of course conceivable to provide at least one of the rollers with a plurality of protrusion elements being spaced along said rotational axes and protruding perpendicularly from said axes.

The outer portions of the protrusion elements on said first roller are arranged in a staggered relationship with the outer portions of the protrusion elements on the second roller. In other words, the rollers and the protrusion elements are placed such that the protrusion elements on the first roller are positioned in between the protrusion elements on the second roller. Further, the outer portions of the protrusion elements on said first roller are partially overlapping with said outer portions of said protrusion elements on said second roller along an imaginary line extending in a width direction, whereby an undulating passage for a web material is formed between said rollers such that the shape of the passage for a web material formed between the protrusion elements is meandering along the imaginary line. The overlap between the protrusion elements has a radial overlap length between 2-40 mm, preferably 2-20 mm, more preferably 3-12 mm, or most preferably between 4-10 mm. Surprisingly, it has been found that when the radial overlap length is in the range mentioned above, preformed lines of weakness are correctly and easily broken, thus allowing an accurate and smooth separation of the web material. Without wishing to be bound by a theory, the inventor believes that this effect is achieved due to the “wrinkling” of the web material in the passage. This wrinkling causes local tension in the web material, which causes the material to burst as the preformed lines of weakness pass through the undulating passage. It is worth noting that the pinch force exercised by the separation unit of the present invention is strong enough to break the preformed lines of weakness, and at the same time weak enough not to damage the web material. Such an optimization of the pinch force is achieved due to the unique geometry of the separation unit.

Thus, by using the separation unit according to the present invention, the risk that any given preformed line of weakness would break before that particular line of weakness has reached the separation unit is eliminated. At the same time, the separation unit according to the present invention facilitates the separation of the web material such that the force needed for separation of the web material is minimized.

The ratio between the radial overlap length and the maximum radial extension of the protrusion elements may be between 4-80%, preferably 15-60%.

The web material mentioned above may in the context of the present invention be tissue paper, such as facial tissue, toilet tissue or paper towels, or may be nonwoven material. As would be understood by the person skilled in the art, the pinch force needed for accurate separation of the web material may need to be altered depending on the type of the web material. In order to provide the separation unit according to the present invention being usable with different types of web material, the distance between the rotational axes of the first and second rollers may be adjustable, thus enabling the radial overlap length in the undulating passage to be variable. This feature of the separation unit makes it very flexible and adaptive.

The protrusion elements of the separation unit according to the present invention may be of any suitable shape, as far as the radial overlap length is within the range specified above. Thus, the protrusion elements may be in the form of disc elements, propeller-shaped elements, cylinder elements or the like. The cross-section in a radial plane of the protrusion elements may be rounded at the outer periphery of the protrusion element. The cross-section at the outer periphery of the protrusion element may also be rectangular, triangular, wavy or the like. The maximum radial extensions of said protrusion elements may be between 5-50 mm, preferably 5-30 mm, more preferably 10-20 mm, or most preferably 12-18 mm. The protrusion elements may be made of any suitable material that provides friction between the outer portion of the protrusion element and the web material. Thus, the protrusion elements may be made of rubber or another elastomeric material.

The protrusion elements may be covered by a sleeve or ring of an elastomeric material encircling the outer periphery of each individual protrusion element. The elastomeric material may be glued, vulcanized or simply stretched around the outer portion of the protrusion element.

The maximum widths of said protrusion elements may be between 4-20 mm, preferably 5-10 mm, most preferably 6-8 mm. As mentioned above, the maximum width of each protrusion element is determined by the dimension of the widest part of the protrusion element. The width of the protrusion element may be same or different along the radial direction. Thus, if the width of the protrusion element is the same along the radial direction, the maximum width within the overlap length is equal to the maximum width of the protrusion element. On the other hand, if the width of the protrusion element is different along the radial direction, the maximum width within the overlap length may be smaller or greater than the maximum width of the protrusion element.

The maximum radial extensions of the protrusion elements may be equal to or greater than the maximum widths of said protrusion elements. The more the difference between the maximum radial extensions and the maximum widths of the protrusion elements, the greater the undulation amplitude of the passage formed between the protrusion elements. This, in turn, means that with increasing undulation amplitude the pinch force increases.

Another advantageous feature of the separation unit according to the present invention is that for at least one of the rollers, the sum of the maximum widths within the overlap length of all protrusion elements on that roller is between 5-30%, preferably between 12-20% of the web width of that roller. By “maximum width within the overlap length” is meant the maximal extension of the protrusion element in the width direction within the overlap length. Thus, the surface of the web material being in contact with the protrusion elements is relatively small compared to the separation units of the prior art, which optimizes the pinch force acting on the web material and provides an accurate separation.

The separation unit according to the present invention may be formed such that the protrusion elements are formed integral with the rollers, or such that the protrusion elements are separate units attached to the roller.

The spacing of the protrusion elements may be the same along the width direction of the first and/or said second roller. Also, the spacing of the protrusion elements may vary along the width direction of the first and/or said second roller. For instance, one of said first and said second rollers may comprise at least a first, a second and a third protrusion element, wherein the spacing between said first and said second protrusion elements along the width direction of said first and/or said second roller differs from the spacing between said second and said third protrusion elements along the width direction of said first and/or said second roller. The protrusion elements may be sparsely arranged in the central portion of the rollers, and concentrated in the peripheral portions of the rollers. If such an arrangement is used, a wrinkleless portion of the web material in the central portion of the roller may be more suitable for gripping by the user when the web material is to be separated.

As mentioned above, the distance between the rotational axes of the first and second rollers may be adjustable, thus enabling the radial overlap length in the undulating passage to be variable. Thus, the rollers may be arranged such that the distance between the rollers is manually changed depending on the type of the web material. Another alternative is that the distance between the rollers is automatically adjustable to provide an optimal separation. Such an automatic adjustment may be enabled by using rollers arranged with a biasing means. The biasing means may be a spring suspension, or suspension acting by gravity. Biasing means facilitate pulling the material through the separation unit when the dispenser is being loaded with a web material. Also, biasing means provides a flexible separation unit enabling a smooth passage of parts of the web material having thickness greater than the web material itself. Such parts may for instance be joints between two bundles of the web material. The distance between said rotational axes of said first and said second rollers may be between 8-100 mm. As will be understood by the person skilled in the art, the distance between the rotational axes may be chosen such that an undulating passage providing an optimal pinch force is formed depending on the type of the web material.

The separation unit according to the present invention may comprise protrusion elements having the same maximum radial extensions and same maximum widths. In other words, all the protrusion elements may be equally sized. The separation unit according to the present invention may comprise protrusion elements having different maximum radial extensions and/or different maximum widths, i.e. the separation unit comprises protrusion elements of different sizes. Thus, a plurality of radial overlaps having different lengths will be formed for every given distance between the rotational axes. In this case, it is essential that the lengths of the radial overlaps formed between each two adjacent protrusion elements are in the range mentioned above.

It has been found that the performance of the separation unit according to the present invention is improved when the spacing between each two protrusion elements is equal to or greater than the maximum width of each protrusion element. Such a relationship between the spacing between the protrusion elements and the maximum widths of the protrusion elements provides for a scarce distribution of the protrusion elements along the rotational axes, which optimizes the pinch force affecting the web material, and facilitates separation of the web material at the desired position.

The separation unit according to the present invention may comprise protrusion elements wherein the maximum radial extensions of the protrusion elements are equal to or greater than said maximum widths of said protrusion elements. This means that the protrusion elements may be relatively large and thin, which contributes to an optimal pinch force of the web material.

The separation unit according to the present invention may be placed in a dispenser. Such a dispenser may comprise a housing defining a web material reservoir, a dispensing opening, a control unit for determining a correct tension and path of the web material, and a separation unit according to the present invention. The dispenser may further comprise a web material contained inside the housing. The web material comprises preformed lines of weakness and may be Z-folded to form a stack, or being in the form of a roll.

A leading portion of the web material is configured to be supported in a dispensing path from the reservoir to the dispensing opening. The leading portion may extend upwardly from the top of the said stack of said web material, or from the peripheral or central part of the roll.

The preformed lines of weakness may be perforation lines formed by alternating bonds and slots and having the perforation strength between 20-80 N/m, preferably 30-45 N/m measured using SS-EN ISO 12625-4:2005. This perforation strength may for instance be achieved by using perforation lines wherein the total bond length/(the total bond length+total slot length) is between 4% and 10%. It is desired to form perforation lines which are strong enough to enable feeding of the web material, but which are also weak enough to enable separation of the sheets along the perforation lines using the separation unit of the present invention. In this context, it is known that also other parameters may influence the strength of the perforation line, such as the paper quality, and the size, shape and distribution of the slots and bonds. However, it is believed that the above-mentioned measure is useful for guiding the person skilled in the art when selecting suitable perforation lines.

The web material may be a two-layer structure, i.e. the web material may comprise at least a first web layer divided into sheet products defined between longitudinally separated preformed lines of weakness extending across the first layer; and at least a second web layer divided into sheet products defined between longitudinally separated lines of weakness extending across the second web layer. The web layers may be interfolded so that the lines of weakness of the first web layer are offset from the lines of weakness of the second web layer in a longitudinal direction.

Further, the dispenser may comprise a feeding mechanism, i.e. a motor to advance a web through the dispenser.

Further features of, and advantages with, the present invention will become apparent when studying the appended claims and the following detailed description. Those skilled in the art will realize that different features of the present invention may be combined to create embodiments other than those described in the following, without departing from the scope of the present invention, as defined by the appended claims.

### BRIEF DESCRIPTION OF THE DRAWINGS

Embodiments of the invention will now be described by way of example with reference to the accompanying drawings, of which:

FIGS. 1a, 1b and 1c show a separation unit according to the present invention;

FIG. 2 shows the separation unit according to the present invention seen in the width direction;

FIG. 3 shows protrusion elements having different dimensions and differently shaped outer portions;

FIG. 4 shows a dispenser comprising the separation unit according to the present invention;

FIG. 5 illustrates embodiments of a dispenser for a web material comprising preformed lines of weakness.

FIG. 6 illustrates embodiments of a separation unit for separating a web material along preformed lines of weakness;

FIG. 7 illustrates the separation unit of FIG. 6 with covers and selected portions removed; and

FIGS. 8 and 9 illustrate cross sections through the separation unit illustrated in FIGS. 6 and 7.

### DETAILED DESCRIPTION

The present invention will now be described more fully with reference to the accompanying drawings, in which example embodiments are shown. However, this invention should not be construed as limited to the embodiments set forth herein. Disclosed features of example embodiments may be combined as readily understood by one of ordinary skill in the art to which this invention belongs. Like numbers refer to like elements throughout. Well-known functions or constructions will not necessarily be described in detail for brevity and/or clarity.

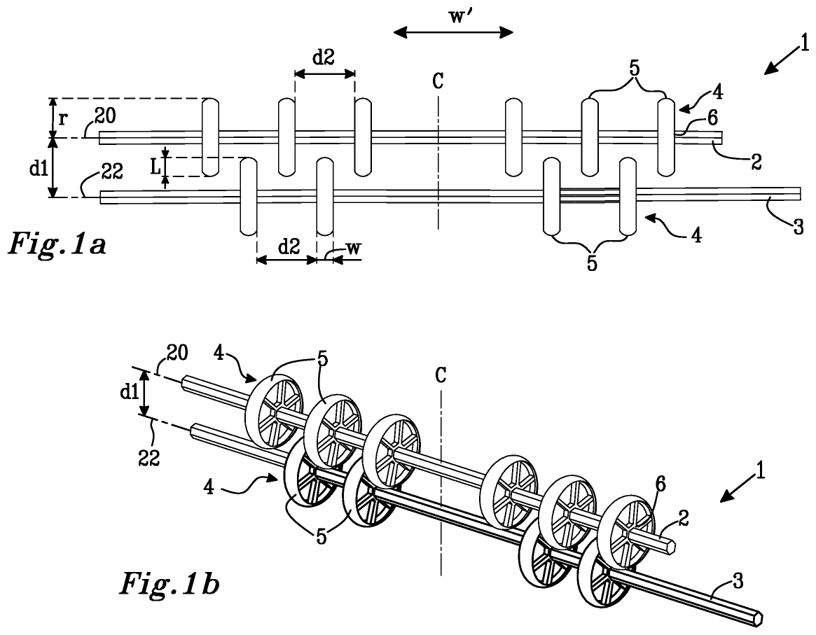

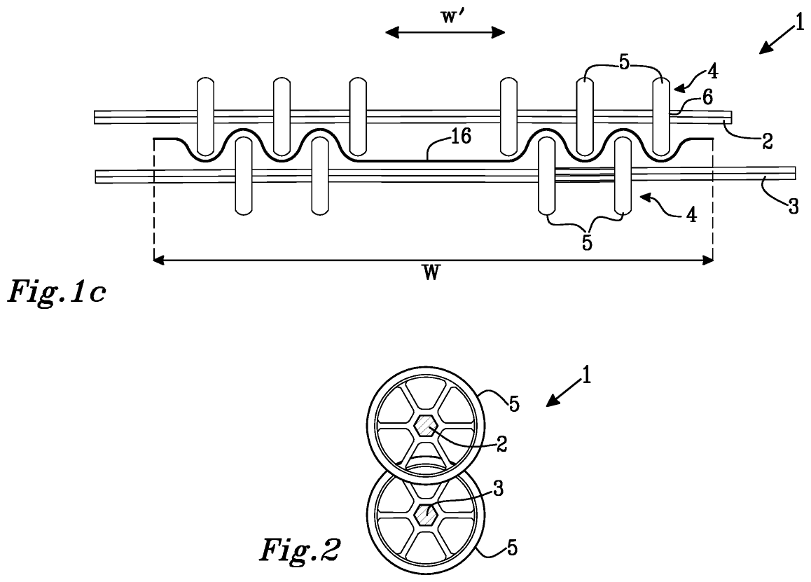

FIGS. 1a and 1b show a separation unit 1 according to the present invention. The separation unit 1 comprises a first roller 2 and a second roller 3, each extending in a width direction and comprising plurality of protrusion elements 4 being spaced along the rollers 2, 3 and protruding perpendicular from the rollers 2, 3. The rollers 2, 3 are positioned at a distance d₁ from each other, wherein the distance d₁ is extending in a direction perpendicular to the width direction of the rollers 2, 3. In the embodiment shown in FIG. 1a, the first roller 2 comprises six protrusion elements 4, and the second roller 3 comprises four protrusion elements 4. The rollers 2, 3 have a web width W (FIG. 1c). Each of the protrusion elements 4 has a maximum width w in the width direction and a maximum radial extension r from the rollers 2, 3. In the embodiment shown in FIG. 1a, the maximum widths w and the maximum radial extensions r of all the protrusion elements 4 are the same. Each protrusion element has an inner portion 6 adjacent to rotational axes 20, 22 of the rollers 2, 3, and an outer portion 5 remote from the rotational axes 20, 22 of the rollers 2, 3, wherein the outer portions 5 of the protrusion elements 4 on the first roller 2 are arranged in a staggered relationship with the outer portions 5 of the protrusion elements 4 on the second roller 3, which is best seen in FIG. 2. The outer portions 5 of the protrusion elements 4 have a slightly curved shape. The outer portions 5 of the protrusion elements 4 on the first roller 2 are partially overlapping with the outer portions 5 of the protrusion elements 4 on the second roller 3 with a radial overlap length L. Such a configuration of the protrusion elements 4 forms an undulating passage for a web material 16 between the rollers 2, 3 (FIG. 1c).

In the embodiment shown in FIGS. 1a and 1b, no protrusion elements are placed in the central portion C of the rollers 2, 3. Such an arrangement of the protrusion elements allows the user to easily access the leading end of the web material 16 in the central portion C of the separation unit 1 (FIG. 1c).

As may be seen in FIGS. 1a and 1b, the spacing d₂ between each two protrusion elements 4 is equal to or greater than the maximum width w of each protrusion element 4. Such a configuration enables the protrusion elements 4 to be relatively scarcely distributed, which provides an optimal pinch force.

Another advantageous feature of the separation unit according to the present invention is that the maximum radial extensions r of the protrusion elements are equal to or greater than the maximum widths w of the protrusion elements. As may be seen in FIGS. 1a and 1b, the protrusion elements are formed as relatively large and thin discs, which optimizes the pinch force.

FIGS. 1a, 1b, and 1c illustrate embodiments of a separation unit 1 for separating a web material 16 along preformed lines of weakness. The separation unit 1 has a width direction W′ and comprises a first roller 2 having a first rotational axis 20 extending in the width direction W′ and a web width W extending in said width direction W′, and at least a second roller 3 having a second rotational axis 22 extending parallel with the first rotational axis 20 of the first roller 2 and a web width W extending in the width direction W′. The second rotational axis 22 of the second roller 3 is positioned at a distance d1 from the first rotational axis 20 of the first roller 2, the distance d1 extending in a direction perpendicular to the width direction W′. Each of the first and the second rollers 2, 3 is provided with at least one protrusion element 4 extending perpendicularly from the rotational axes 20, 22. Each of the protrusion elements 4 has a maximum width w in the width direction W′, a maximum radial extension from each of the rotational axes 20, 22, an inner portion 6 adjacent to the respective of each rotational axis 20, 22, and an outer portion 5 remote from the respective of each rotational axis 20, 22. The outer portions 5 of the protrusion elements 4 on the first roller 2 are arranged in a staggered relationship with the outer portions 5 of the protrusion elements 4 on the second roller 3. The outer portions 5 of the protrusion elements 4 on the first roller 2 are partially overlapping with the outer portions 5 of the protrusion elements 4 on the second roller 3 with a radial overlap length L, thus forming an undulating passage for a web material 16 between the rollers 2, 3. The distance d1 between the rotational axes 20, 22 of the first and the second rollers 2, 3 is adjustable, enabling the radial overlap length L in the undulating passage to be variable.

The distance d1 between the rotational axes 20, 22 may be adjustable in different manners; either automatically by a biasing means, or manually by setting a position of the first roller 2 or the second 3, or by both automatically and manually, such as e.g. describe below. A nip is formed between the first and second rollers 2, 3, through which nip the web material is arranged to pass. A preformed line of weakness of the web material 16 may break either within the nip or outside nip, as the web material 16 passes through the nip. Thus, a sheet of web material may be separated from a leading portion of continuous web material.

FIG. 2 illustrates the separation unit 1 seen in the width direction. It is clearly shown that the outer portions 5 of the protrusion elements 4 on the first roller 2 overlap with the outer portions 5 of the protrusion elements 4 on the second roller 3.

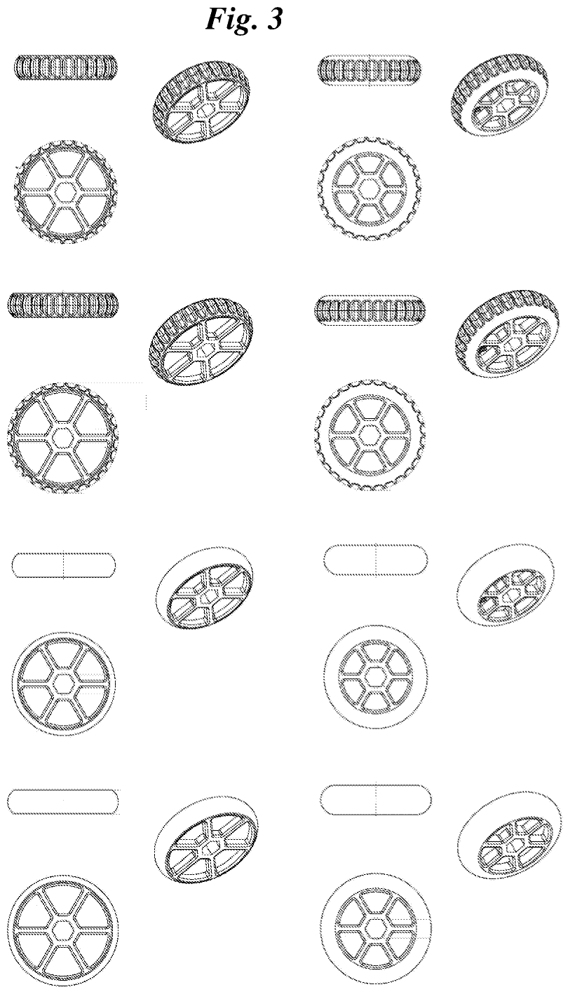

As previously mentioned, the protrusion elements 4 may have different maximum widths w and maximum radial extension r. In FIG. 3, protrusion elements, in the form of disc elements, having different maximum widths w and different maximum radial extensions r are shown.

As mentioned above, the shape of the outer portions 5 of the protrusion elements 4 may vary. In FIG. 3, four possible shapes of the outer portions 5 are depicted. Thus, the outer portions may have a smooth surface, or may be provided with a ribbed surface.

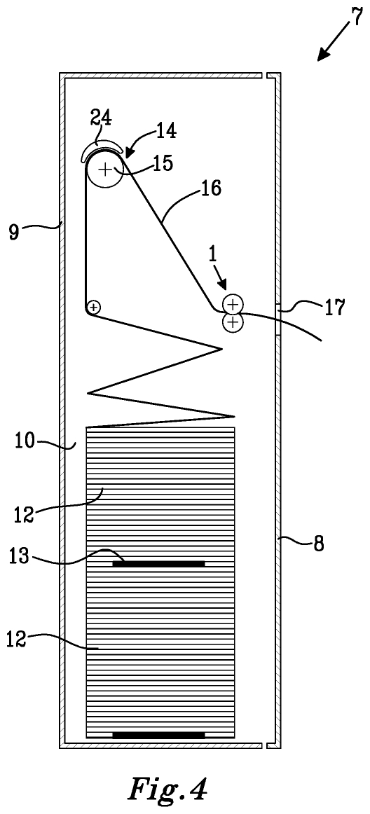

FIG. 4 schematically shows a dispenser 7 with a separation unit 1 according to the present invention. The dispenser 7 has an outer front wall 8, two outer side walls 9 and a housing 10. The housing 10 is intended for holding a pile, or stack, of a continuous length of accordion-like folded web of towels of tissue paper or nonwoven, also referred to a web material, comprising bundles 12 of a continuous length of accordion-like folded web of towels of tissue paper or nonwoven. Thus, the housing 10 defines a web material reservoir. The bundles 12 comprise connecting means 13 between the bundles 12. The dispenser 7 comprises a guiding element 14 in the form of a curved plate 24 which extends over a segment of a web-supporting element 15. The at least one web 16 is arranged to be fed through the guiding element 14 when the dispenser 7 is in use, and at least one part of the guiding element 14 is arranged to bear against the web 16. The guiding element 14 thereby holds the at least one web 16 in place on the web-supporting element 15 so that it does not move backwards or sidewards during the use of the dispenser, or in case of web-breakage.

The unit subsequent to the guiding element 14 is separation unit 1 described above. The separation unit 1 provides an optimal pinch force acting on the web material 16, and allows the web material 16 to be separated at the desired position. The separation unit 1 depicted in FIG. 4 is configured such that both of the rollers 2, 3 are positioned inside the housing 10. It is also conceivable that one of the rotational axes is located in the outer front wall 8, such that when the outer front wall 8 is opened, the pinch force caused by the separation unit 1 is released.

The dispenser 7 illustrated in FIG. 4 comprises a stack of interfolded webs 16, whereby the dispenser 7 is configured so that the stack of interfolded webs in the housing 10 has to be lifted to position a new bundle 12 of web material in the housing 10 underneath the stack to refill the dispenser 7. Bundles 12 of interfolded webs in the dispenser 7 may be interconnected via connecting means 13, such as adhesive, adhesive tape or mechanical fasteners, such as hook and loop fasteners, at the bottom and/or top of each of the refill stacks. The web 16 is arranged to be fed upwards within the housing 10, around the web-supporting element 15 located at the top of the dispenser 7 and downwards towards the separation unit 1 and the dispensing opening 17.

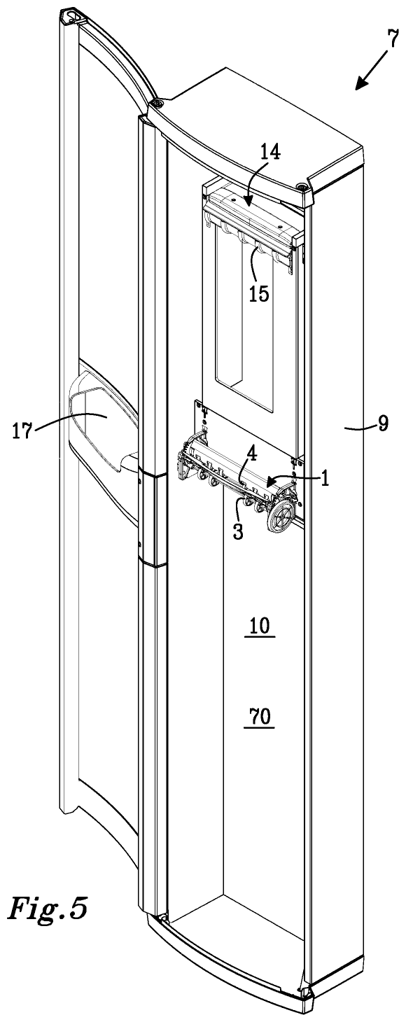

FIG. 5 illustrates embodiments of a dispenser 7 for a web material comprising preformed lines of weakness. The dispenser 7 comprises a housing 10 defining a web material reservoir 70, a dispensing opening 17, and a separation unit 1 according to aspects and embodiments discussed herein. The dispenser is arranged for manual dispensing of web material through the dispensing opening 17 by a user pulling on a leading portion of the web material. In the web material reservoir 70 a stack of folded web material for dispensing sheets of web material therefrom may be provided. The web material may be Z-folded to form the stack. One or more bundles of folded web material may be used to replenish the stack of folded web when the housing 10 of the dispenser 7 is open, as illustrated in FIG. 5. A leading portion of the web material is arranged to extend from a top of the stack of web material in the web material reservoir 70 to the dispensing opening 17 of the dispenser 7. The leading portion of the web material changes direction inside the dispenser between the upper end portion of the web material reservoir 70 and the dispensing opening 17. This may for instance be achieved by a guiding element 14 as described in connection with FIG. 4. The guiding element 14 is an example of control unit for determining a correct tension and path of the web material.

In FIG. 5 the dispenser 7 is depicted in the state when no web material 16 is loaded. The separation unit 1 is positioned within the housing 10 at the same level as the dispensing opening 17, such that the perforated web 16 is separated along the preformed lines of weakness at the moment of dispensing with almost no effort from the user's side.

It should be noted that the dispenser 7 according to the present invention may be any type of automatic or non-automatic dispenser for dispensing at least one web, i.e. a plurality of webs may be dispensed simultaneously, or a plurality of different webs may be dispensed by the dispenser 7 one at a time.

The dispenser 7 is a free-standing unit, but the dispenser may also be mounted on any suitable object in any suitable manner. Furthermore, a dispenser housing 10 of a dispenser according to the present invention need not necessarily contain an entire web 16 that is to be dispensed by the dispenser 7. At least one web 16 may for example be stored outside the housing 10 and merely be fed through the housing 10 when the dispenser 7 is in use.

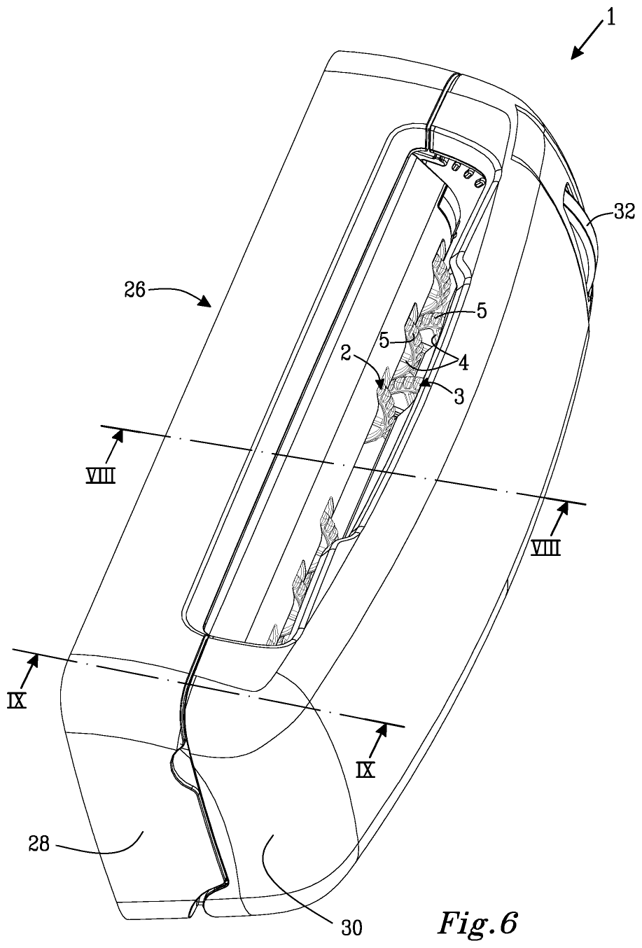

FIG. 6 illustrates embodiments of a separation unit 1 for separating a web material along preformed lines of weakness. The separation unit 1 comprises a first roller 2 having a first rotational axis and a second roller 3 having a second rotational axis extending parallel with the first rotational axis. The second rotational axis of the second roller 3 is positioned at a distance from the first rotational axis of the first roller 2. Each of the first and the second rollers 2, 3 is provided with at least one protrusion element 4 extending perpendicularly from the rotational axes. Each of the protrusion elements 4 has an outer portion 5 remote from the respective of each rotational axis. The outer portions 5 of the protrusion elements 4 on the first roller 2 are arranged in a staggered relationship with the outer portions 5 of the protrusion elements 4 on the second roller 3. The outer portions 5 of the protrusion elements 4 on the first roller 2 are partially overlapping with the outer portions 5 of the protrusion elements 4 on the second roller 3 with a radial overlap length, thus forming an undulating passage for a web material between the rollers 2, 3. The distance between the rotational axes 20, 22 of the first and the second rollers 2, 3 is adjustable, enabling the radial overlap length in the undulating passage to be variable. The separation unit 1 may form part of a dispenser 7, e.g. as disclosed in FIGS. 4 and 5, for dispensing sheets of web material from a stack of folded web material, or a dispenser 7 for dispensing sheets of web material from a roll of web material. The first and second rollers 2, 3 are rotatably arranged in a frame 26. The frame 26 comprises a first frame portion 28 comprising the first roller 2 and a second frame portion 30 comprising the second roller 3. The second frame portion 30 may be moved away from the first frame portion 28 to open the frame 26. The second roller 3 is moved away from the first roller 2 together with the second frame portion 30 to permit web material to be threaded between the first and second rollers 2, 3. That is, when the second roller 3 is moved away from the first roller 2, the outer portions 5 of the protrusion elements 4 do not overlap to permit the threading of the web material between the first and second rollers 2, 3. Furthermore, to facilitate threading of web material between the first and second rollers 2, 3 when the frame 26 is closed, the second roller 3 is provided with an actuation wheel 32, which may be manually rotated to advance web material between the first and second rollers 2, 3 to a graspable position.

The second rotational axis 22 is fixed in the second frame portion 30, i.e. when the frame 26 is closed the second rotational axis 22 is fixed in relation to the frame 26, as opposed to the first rotational axis 20. Namely, in the first frame portion 28, the first roller 2 is movably suspended, perpendicularly to the first rotational axis 20. Biasing means are arranged to bias the first roller 2 towards the second roller 3.

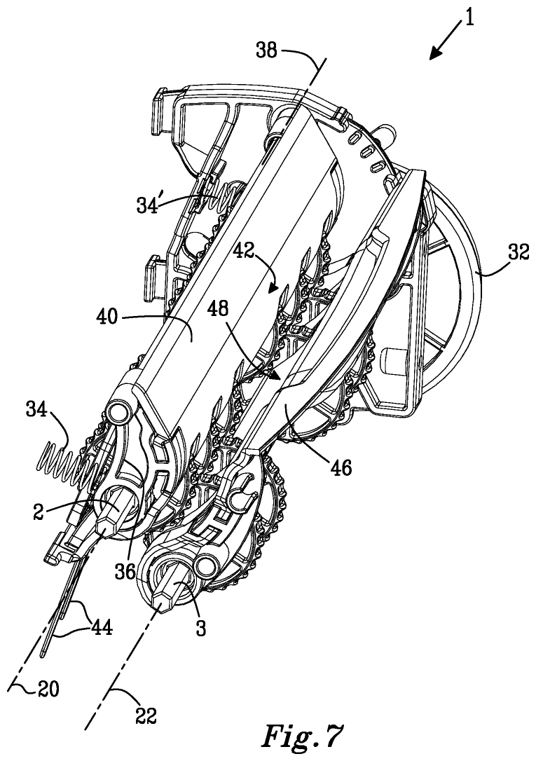

FIG. 7 illustrates the separation unit 1 of FIG. 6 with covers and selected portions removed to reveal inter alia, the first and second rollers 2, 3, the biasing means, and a suspension of the first roller 2. The first roller 2 is arranged to rotate about the first rotational axis 20 and the second roller 3 is arranged to rotate about the second rotational axis 22. During use of the separation unit 1 for separating sheets of web material from a web material comprising preformed lines of weakness, i.e. when the frame 26 is closed, the second rotational axis 22 is fixed in the separation unit 1.

As mentioned above, the first roller 2 is movably suspended, perpendicularly to the first rotational axis 20. The biasing means is arranged to bias the first roller 2 towards the second roller 3. In these embodiments the biasing means comprises two helical pressure springs 34, 34′.

The separation unit 1 comprise a cradle 36. The cradle 36 is pivotably suspended to pivot about a pivot axis 38 substantially parallel with the rotational axes 20, 22. The first roller 2 is suspended in the cradle 36. Thus, the first roller 2 is movably suspended. As the cradle 36 pivots about the pivot axis 38 the first roller 2 moves with the cradle 36. Accordingly, the distance between the rotational axes 20, 22 of the first and the second rollers 2, 3 is adjustable.

The springs 34, 34′ of the biasing means are illustrated in a compressed state in FIG. 7 and each abut at one end against the cradle 36 and at an opposite end to fixed portions (not shown) of the frame of the separation unit 1. Accordingly, the biasing means engage with the cradle 36 to bias the first roller 2 towards the second roller 3. The biasing means enables an automatic adjustment of the distance between the rotational axes 20, 22.

The separation unit 1 comprises a first guiding part 40 separate from the first roller 2. The first guiding part 40 is arranged in connection with the first roller 2 and comprises a first guiding surface 42 for the web material. The first guiding surface 42 may extend both upstream and downstream of the first roller 2 as well as between at least some of the protrusion elements 4 of the first roller 2. In these embodiments the first guiding part 40 extends with at least one protruding portion 44 upstream of the first roller 2, i.e. below the first roller 2 in FIG. 7. The first guiding part 40 is connected with, and movable/pivotable together with, the cradle 36. The separation unit 1 comprises a second guiding part 46 separate from the second roller 3. The second guiding part 46 is arranged in connection with the second roller 3 and comprises a second guiding surface 48 for the web material. The second guiding surface 48 may extend both upstream and downstream of the second roller 3 as well as between at least some of the protrusion elements 4 of the second roller 3.

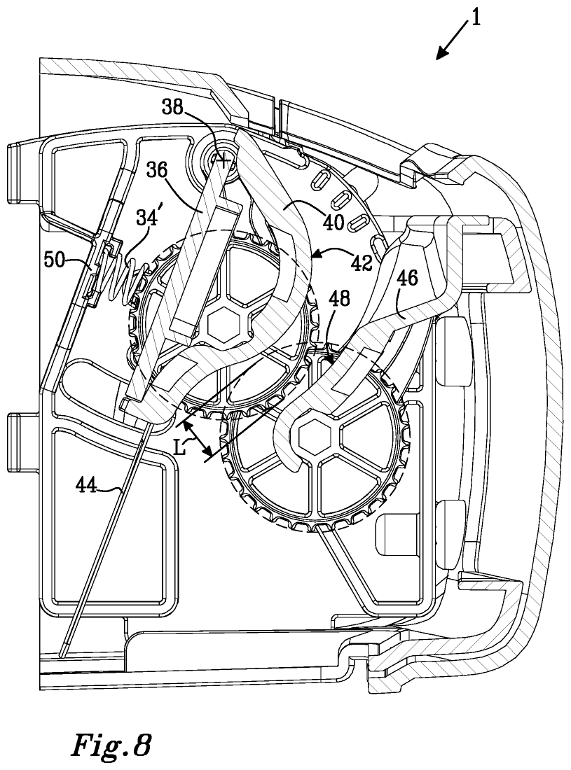

FIG. 8 illustrates a cross section perpendicular to the first and second rotational axes through the separation unit 1 of FIGS. 6 and 7. The first and second guiding parts 40, 46 and their respective first and second guiding surfaces 42, 48, as well as the at least one protruding portion 44 are clearly visible. Moreover, the radial overlap length L of the outer portions 5 of protrusion elements 4, a fixed portion 50 of the separation unit 1 against which one of the helical springs 34′ of the biasing means abuts, the cradle 36, and the pivot axis 38 are also clearly visible.

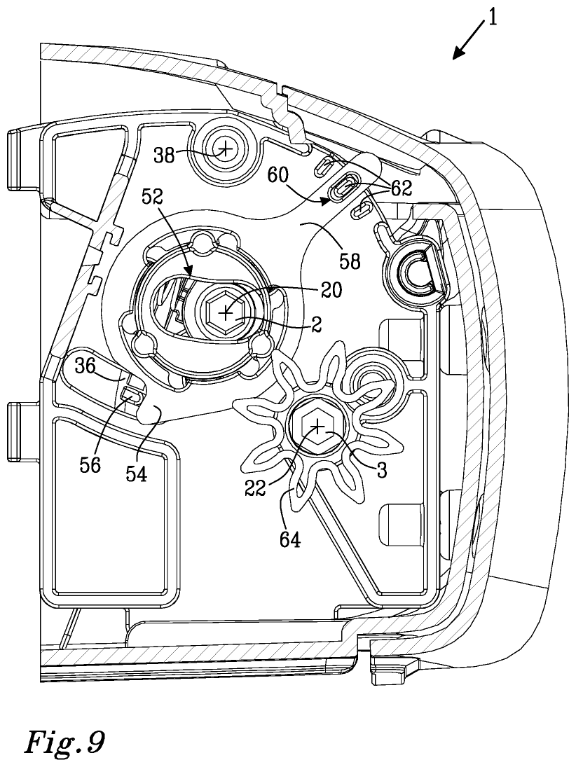

FIG. 9 illustrates a cross section perpendicular to the first and second rotational axes through the separation unit 1 of FIGS. 6, 7, and 8. The cross section is taken at one end of the first and second rollers 2, 3. The rollers 2, 3 are arranged such that the distance between the rotational axes 20, 22 of the first and the second rollers 2, 3 is manually changeable. Thus, the radial overlap length L may be set for web material of different kinds. Accordingly, the distance between the rotational axes 20, 22 of the first and the second rollers 2, 3 is adjustable.

More specifically, an end position of the first roller 2 is arranged to be manually changed. Namely, the biasing means biases the first roller 2 towards an end position, from which end position the first roller 2 is movable only in a direction away from the second roller 3. As previously mentioned, the cradle 36 is pivotable about the pivot axis 38 and the first roller 2 moves with the cradle 36. The frame of the separation unit 1 is provided with a slot 52 through which an end portion of the first roller 2 passes thus, permitting the cradle 36 and the first roller 2 to pivot about the pivot axis 38.

The separation unit 1 comprises a stopper device 54, against which the cradle 36 is biased to abut. The first roller 2 is arranged in the end position when the cradle 36 abuts against the stopper device 54. For this purpose the cradle 36 is provided with a shoulder 56, which is arranged to abut against the stopper device 54. Thus, the first roller 2 is biased towards the end position and the smallest distance between the first and second rollers 2, 3 is defined by the cradle 36 when its shoulder 56 abuts against the stopper device 54.

The stopper device 54 is movable between at least two fixed positions to define at least two corresponding end positions for the first roller 2. For this purpose the stopper device 54 in these embodiments is rotatably arranged in the separation unit 1. The stopper device 54 is manually rotatable about a portion of the separation unit 1 comprising the slot 52. The stopper device 54 is fixed by an engaging portion 58 of the stopper device 54 engaging with the frame of the separation unit 1. In order to fix the stopper device 54 the engaging portion 58 is provided with a hole 60 and the frame of the separation unit 1 is provided with at least one projection 62 arranged to extend at least partially through the hole 60. In these embodiments the stopper device 54 is movable between three fixed positions. Accordingly, the frame of the separation unit 1 is provided with three projections 62 to permit the engaging portion 58 to be fixed in one of three positions. Thus, the smallest distance between the first and second rollers 2, 3, may be set by moving the stopper device 54 to one of at least two fixed positions, i.e. three fixed positions in these embodiments. The engaging portion 58 is manually movable between the three projections 62.

Mentioned purely as an example, the radial overlap length L between the outer portions 5 of the protrusion elements 4 in each of the three fixed positions of the stopper device 54, and accordingly in the three corresponding end positions of the first roller 2, may be approx. 6 mm, approx. 7 mm, and approx. 8 mm, respectively. When the radial overlap length L is 8 mm, the biasing means may provide a force of 3.7 N towards the second roller 3. When the radial overlap length L is 6 mm, the biasing means may provide a force of 5.3 N towards the second roller 3.

The second roller 3 is provided with a cog wheel 64. Also the first roller 2 is provided with a cog wheel (not shown). The two cog wheels engage with each other. Thus when the actuation wheel 32 is rotated, both rollers 2, 3 are rotated.

Although the present invention has been described with reference to various embodiments, those skilled in the art will recognize that changes may be made without departing from the scope of the invention. It is intended that the detailed description be regarded as illustrative and that the appended claims including all the equivalents are intended to define the scope of the invention.

Example embodiments described above may be combined as understood by a person skilled in the art. Although the invention has been described with reference to example embodiments, many different alterations, modifications and the like will become apparent for those skilled in the art. For instance, the second roller 3 may be biased towards the first roller 2, instead of the first roller 2 being biased towards the second roller 3, or in addition to the first roller 2 being biased towards the second roller 3. The first and/or the second rollers 2, 3 may comprise separate roller portions aligning along the respective first and second rotational axes 20, 22.

As used herein, the term “comprising” or “comprises” is open-ended, and includes one or more stated features, elements, steps, components or functions but does not preclude the presence or addition of one or more other features, elements, steps, components, functions or groups thereof.

1-22. (canceled)

23. A separation unit for separating a web material along preformed lines of weakness, said separation unit having a width direction and comprising
at least a first roller having a rotational axis extending in said width direction, a rotation direction, and a web width extending in said width direction, and
at least a second roller having a rotational axis extending parallel with said rotational axis of said first roller, a rotation direction, and a web width extending in said width direction, said rotational axis of said second roller being positioned at a distance from said rotational axis of said first roller, said distance extending in a direction perpendicular to said width direction,
wherein the rotation direction of the first roller is opposite the rotation direction of the second roller,
wherein each of said first and said second rollers is provided with at least one protrusion element extending perpendicularly from said axes,
wherein each of said protrusion elements has a maximum width in said width direction, a maximum radial extension from said rotational axes, an inner portion adjacent to said rotational axes, and an outer portion remote from said rotational axes,
wherein said outer portions of said protrusion elements on said first roller are arranged in a staggered relationship with said outer portions of said protrusion elements on said second roller,
wherein said outer portions of said protrusion elements on said first roller are partially overlapping with said outer portions of said protrusion elements on said second roller with a radial overlap length, thus forming an undulating passage for a web material between said rollers,
wherein said distance between said rotational axes of said first and said second rollers is adjustable, enabling said radial overlap length in said undulating passage to be variable,
wherein a biasing means arranged with said first and second rollers enables an automatic adjustment of said distance between said rotational axes of said first and said second rollers,
wherein the separation unit is configured such that the preformed lines of weakness will rupture in the separation unit to separate a sheet of web material,
wherein said first roller is movably suspended, perpendicularly to said first rotational axis, and wherein said biasing means is arranged to bias said first roller towards said second roller,
wherein the separation unit further comprises a cradle, said cradle being pivotably suspended to pivot about a pivot axis substantially parallel with said rotational axes, wherein said first roller is suspended in said cradle.

24. The separation unit according to claim 23, wherein said rollers are arranged such that said distance between said rotational axes of said first and said second rollers is manually changeable.

25. The separation unit according to claim 23, wherein said biasing means engages with said cradle to bias said first roller towards said second roller.

26. The separation unit according to claim 23, wherein said rotational axis of said second roller is fixed.

27. The separation unit according to claim 23, wherein said biasing means biases said first roller towards an end position, from which end position said first roller is movable in a direction away from said second roller.

28. The separation unit according to claim 23, wherein said cradle is biased to abut against a stopper device, and wherein said first roller is arranged in said end position when said cradle abuts against said stopper device.

29. The separation unit according to claim 28, wherein said stopper device is movable between at least two fixed positions to define at least two corresponding end positions for said first roller.

30. The separation unit according to claim 23, wherein the radial overlap length is between 4-40 mm, prior to variance allowed by the biasing means.

31. The separation unit according to claim 23, wherein said biasing means comprises a spring.

32. The separation unit according to claim 23, comprising a first guiding part separate from said first roller,
wherein said first guiding part is arranged in connection with said first roller and comprises a first guiding surface for said web material.

33. The separation unit according to claim 32, wherein said first guiding part is connected with, and movable together with, said cradle.

34. The separation unit according to claim 32, comprising a second guiding part separate from said second roller,
wherein said second guiding part is arranged in connection with said second roller and comprises a second guiding surface for said web material.

35. The separation unit according to claim 23, wherein said protrusion elements are disc elements.

36. A dispenser for a web material comprising preformed lines of weakness, the dispenser comprising a housing defining a web material reservoir, and a dispensing opening,
wherein said dispenser comprises a separation unit according to claim 23.

37. The dispenser according to claim 36, comprising a control unit for determining a correct tension and path of said web material.

38. The dispenser according to claim 36, wherein said dispenser is adapted for containing a web material comprising preformed lines of weakness, said web material being Z-folded to form a stack.

39. The dispenser according to claim 36, wherein said dispenser is adapted for containing a web material comprising preformed lines of weakness, said web material being in the form of a roll.

40. The dispenser according to claim 36, wherein said dispenser further comprises a feeding mechanism for feeding said web material.

41. The dispenser according to claim 38, wherein said reservoir is adapted to contain said web material, and
wherein a leading portion of said web material is arranged to be supported at least partially along a dispensing path from said reservoir to said dispensing opening.

42. The dispenser according to claim 41, wherein said leading portion is arranged to extend upwardly from a top of said stack.

43. The separation unit according to claim 23, wherein a nip is formed between said first and second rollers, through which nip the web material is arranged to pass, wherein the separation unit is configured to break the preformed line of weakness within the nip in order to separate the web material.

44. The dispenser according to claim 36, wherein a nip is formed between said first and second rollers, through which nip the web material is arranged to pass, wherein the separation unit is configured to break the preformed line of weakness within the nip in order to separate the web material.

45. A separation unit for separating a web material along preformed lines of weakness, said separation unit having a width direction and comprising
at least a first roller having a rotational axis extending in said width direction and a web width extending in said width direction, and
at least a second roller having a rotational axis extending parallel with said rotational axis of said first roller and a web width extending in said width direction, said rotational axis of said second roller being positioned at a distance from said rotational axis of said first roller, said distance extending in a direction perpendicular to said width direction,
wherein each of said first and said second rollers is provided with at least one protrusion element extending perpendicularly from said axes,
wherein each of said protrusion elements has a maximum width in said width direction, a maximum radial extension from said rotational axes, an inner portion adjacent to said rotational axes, and an outer portion remote from said rotational axes,
wherein said outer portions of said protrusion elements on said first roller are arranged in a staggered relationship with said outer portions of said protrusion elements on said second roller,
wherein said outer portions of said protrusion elements on said first roller are partially overlapping with said outer portions of said protrusion elements on said second roller with a radial overlap length, thus forming an undulating passage for a web material between said rollers,
wherein said distance between said rotational axes of said first and said second rollers is adjustable, enabling said radial overlap length in said undulating passage to be variable,
wherein a biasing means arranged with said first and second rollers enables an automatic adjustment of said distance between said rotational axes of said first and said second rollers,
wherein the separation unit is configured such that the preformed lines of weakness will rupture in the separation unit to separate a sheet of web material,
wherein said first roller is movably suspended, perpendicularly to said first rotational axis, and wherein said biasing means is arranged to bias said first roller towards said second roller,
wherein the separation unit further comprises a cradle, said cradle being pivotably suspended to pivot about a pivot axis substantially parallel with said rotational axes, wherein said first roller is suspended in said cradle,
wherein the separation unit is configured for manual separation of web material by a user pulling on a leading portion of the web material.

46. The separation unit according to claim 45, wherein said rollers are arranged such that said distance between said rotational axes of said first and said second rollers is manually changeable.

47. The separation unit according to claim 45, wherein said biasing means engages with said cradle to bias said first roller towards said second roller.

48. The separation unit according to claim 45, wherein said rotational axis of said second roller is fixed.

49. The separation unit according to claim 45, wherein said biasing means biases said first roller towards an end position, from which end position said first roller is movable in a direction away from said second roller.

50. The separation unit according to claim 45, wherein said cradle is biased to abut against a stopper device, and wherein said first roller is arranged in said end position when said cradle abuts against said stopper device.

51. The separation unit according to claim 50, wherein said stopper device is movable between at least two fixed positions to define at least two corresponding end positions for said first roller.

52. The separation unit according to claim 45, wherein the radial overlap length is between 4-40 mm, prior to variance allowed by the biasing means.

53. The separation unit according to claim 45, wherein said biasing means comprises a spring.

54. The separation unit according to claim 45, comprising a first guiding part separate from said first roller,
wherein said first guiding part is arranged in connection with said first roller and comprises a first guiding surface for said web material.

55. The separation unit according to claim 54, wherein said first guiding part is connected with, and movable together with, said cradle.

56. The separation unit according to claim 54, comprising a second guiding part separate from said second roller,
wherein said second guiding part is arranged in connection with said second roller and comprises a second guiding surface for said web material.

57. The separation unit according to claim 45, wherein said protrusion elements are disc elements.

58. A dispenser for a web material comprising preformed lines of weakness, the dispenser comprising a housing defining a web material reservoir, and a dispensing opening,
wherein said dispenser comprises a separation unit according to claim 45.

59. The dispenser according to claim 58, comprising a control unit for determining a correct tension and path of said web material.

60. The dispenser according to claim 58, wherein said dispenser is adapted for containing a web material comprising preformed lines of weakness, said web material being Z-folded to form a stack.

61. The dispenser according to claim 58, wherein said dispenser is adapted for containing a web material comprising preformed lines of weakness, said web material being in the form of a roll.

62. The dispenser according to claim 58, wherein said dispenser further comprises a feeding mechanism for feeding said web material.

63. The dispenser according to claim 60, wherein said reservoir is adapted to contain said web material, and
wherein a leading portion of said web material is arranged to be supported at least partially along a dispensing path from said reservoir to said dispensing opening.

64. The dispenser according to claim 63, wherein said leading portion is arranged to extend upwardly from a top of said stack.

65. The separation unit according to claim 45, wherein a nip is formed between said first and second rollers, through which nip the web material is arranged to pass, wherein the separation unit is configured to break the preformed line of weakness within the nip in order to separate the web material.

66. The dispenser according to claim 63, wherein a nip is formed between said first and second rollers, through which nip the web material is arranged to pass, wherein the separation unit is configured to break the preformed line of weakness within the nip in order to separate the web material.
